(19) United States
(12) Patent Application Publication
(10) Pub. No.: US 2017/0061749 A1
(43) Pub. Date: Mar. 2, 2017

(54) PROGRESS TRACKING MECHANISM FOR A HOME APPLIANCE

(71) Applicant: WHIRLPOOL CORPORATION, Benton Harbor, MI (US)

(72) Inventors: Wayne W. Conard, Stevensville, MI (US); Charles R. Cravens, St. Joseph, MI (US); Steven R. Gordon, St. Joseph, MI (US); Muhammad Khizar, St. Joseph, MI (US); Brandon T. Mock, St. Joseph, MI (US); Kenneth W. Perry, JR., Caledonia, MI (US)

(73) Assignee: WHIRLPOOL CORPORATION, Benton Harbor, MI (US)

(21) Appl. No.: 14/839,274

(22) Filed: Aug. 28, 2015

(51) Int. Cl. G08B 5/36

(52) U.S. Cl. CPC G08B 5/36

(57) ABSTRACT

A progress tracking mechanism provided on a home appliance is disclosed herein and includes a plurality of light sources and a controller electrically coupled to the light sources. When a timed activity is being performed by the home appliance, the controller selectively controls an operational state of each of the light sources to visually indicate the progress of the timed activity.

### BACKGROUND

The present concept generally relates to a progress tracking mechanism, and more particularly, to a progress tracking mechanism for use with a home appliance.

### SUMMARY

According to one aspect of this disclosure, a progress tracking mechanism provided on a home appliance is disclosed and includes a plurality of light sources and a controller electrically coupled to the light sources. When a timed activity is being performed by the home appliance, the controller selectively controls an operational state of each of the light sources to visually indicate the progress of the timed activity.

According to another aspect of this disclosure, a progress tracking mechanism provided on a home appliance is disclosed. A plurality of light sources are arranged in a ring pattern. A controller is electrically coupled to the light sources. When a timed activity is being performed by the home appliance, the controller selectively controls an ON/OFF state and a variable brightness level of each of the light sources to visually indicate the progress of the timed activity.

According to yet another aspect of this disclosure, a method for tracking the progress of a timed activity performed by a home appliance is disclosed. The method includes the steps of arranging a plurality of light sources in a ring pattern, initiating a timed activity to be performed by the home appliance and selectively controlling an operational state of each of the light sources to visually indicate the progress of the timed activity.

These and other aspects, objects, and features of the present disclosure will be understood and appreciated by those skilled in the art upon studying the following specification, claims, and drawings.

### BRIEF DESCRIPTION OF THE DRAWINGS

In the drawings:

FIG. 1 illustrates a blender equipped with a progress tracking mechanism;

FIG. 2 illustrates one embodiment of the progress tracking mechanism;

FIG. 3 illustrates a light transmissive cover being used in conjunction with the progress tracking mechanism;

FIG. 4 illustrates a dial being used in conjunction with the progress tracking mechanism;

FIGS. 5 and 6 together illustrate a plurality of light sources of the progress tracking mechanism being sequentially deactivated to visually indicate the progress of a timed activity;

FIG. 7 illustrates the light sources of the progress tracking mechanism being sequentially activated to visually indicate the progress of a timed activity;

FIGS. 8-12 together illustrate the light sources of the progress tracking mechanism being progressively dimmed to visually indicate the progress of a timed activity; and

FIG. 13 is a flow chart of a method for tracking the progress of a timed activity performed by a home appliance.

### DETAILED DESCRIPTION

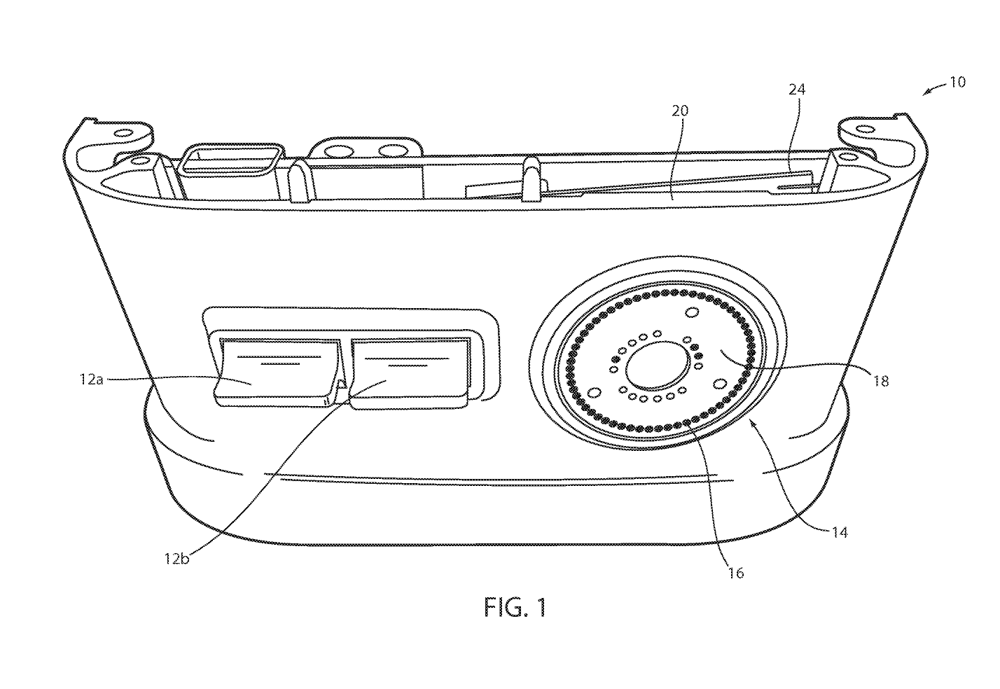

For purposes of description herein, the terms “upper,” “lower,” “right,” “left,” “rear,” “front,” “vertical,” “horizontal,” and derivatives thereof shall relate to the disclosure as oriented in FIG. 1. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be contemplated as limiting, unless the claims expressly state otherwise.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

Referring to FIG. 1, a base section 10 of a blender is shown for purposes of simplicity and illustration. The base section 10 generally corresponds to the front of the blender and may include a variety of user-input switches, exemplarily shown as switches 12a and 12b, for enabling a user to select among a variety of activities to be performed by the blender. A progress tracking mechanism 14 is provided on the base section 10 to track the progress of a selected activity being performed by the blender. The progress tracking mechanism 14 includes a plurality of light sources, shown as light emitting diodes (LEDs) 16 disposed on a printed circuit board (PCB) 18 coupled to a wall 20 of the base section 10.

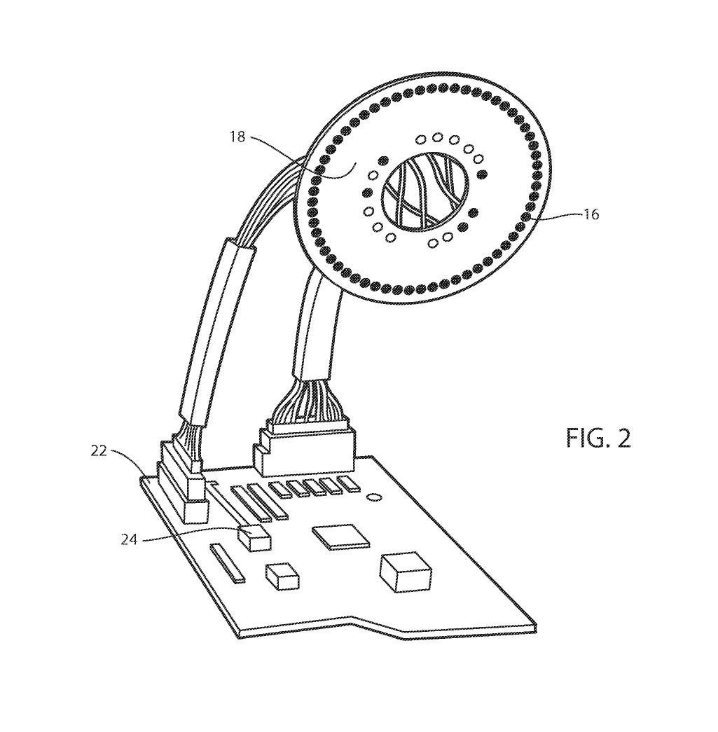

The LEDs 16 may be ordered in a sequence to form a ring pattern and are electrically coupled to a control circuit 22 disposed on a separate PCB 24 (see FIG. 2) that is generally supported inside the blender. The LEDs 16 may vary in size and quantity, and may output the same colored light or different colored light, if desired. According to one embodiment, the LEDs 16 may be selected to emit red light, green light, blue light, or a combination thereof including white light. Additionally, the LEDs 16 may be selected to have a correlated color temperature (CCT) between 4400 and 60,000, a color rendering index (CRI) from 75 to 90, and a light intensity from 650 to 1800 lumen (lm). The PCB 18 on which the LEDs 16 are located may vary in dimension. In the presently illustrated embodiment, the PCB 18 has a circular arrangement, but may be otherwise configured in order to be coupled to other types of structures. The PCB 24 on which the control circuit 22 is located may also be variously dimensioned and packaged within the base section 10 of the blender. The control circuit 22 may be electrically coupled to the same power source as the other electrical components of the blender or an independent power source such as a battery.

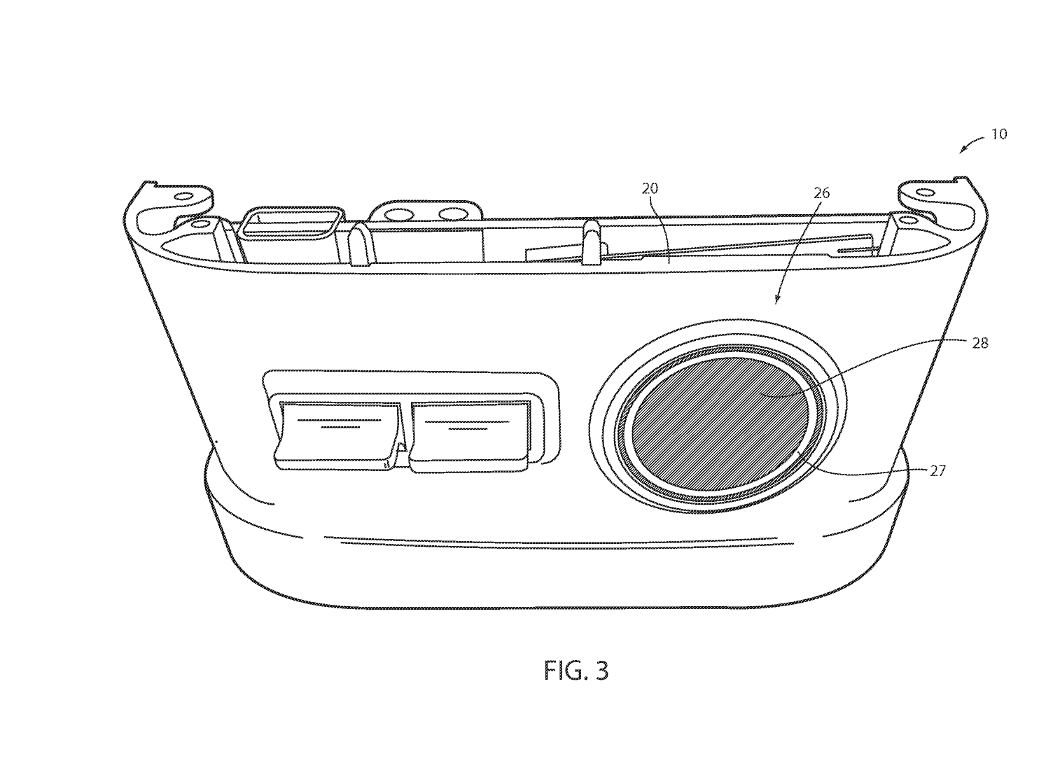

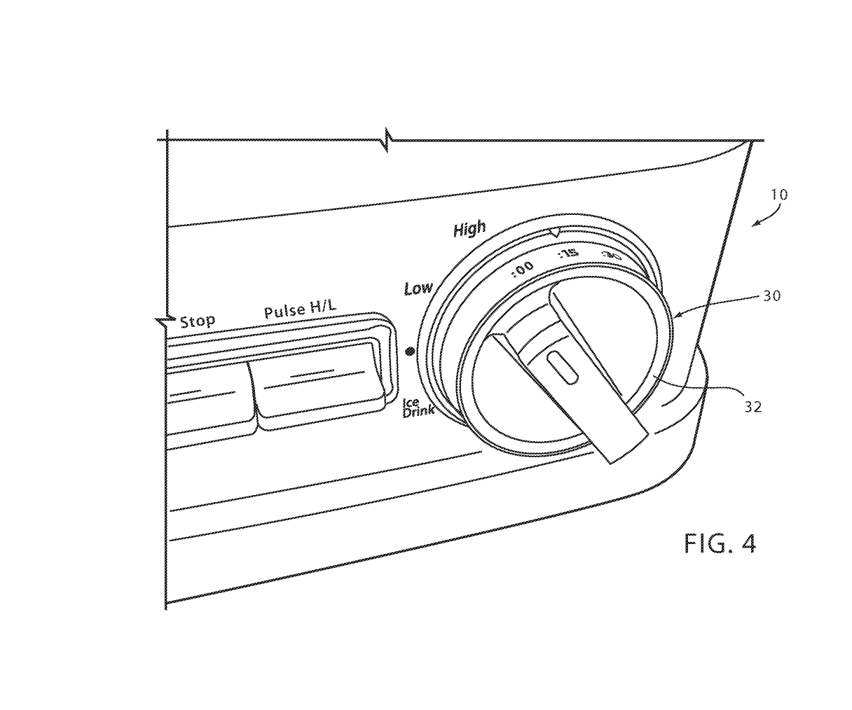

As exemplarily shown in FIG. 3, a cover 26 may be arranged over the LEDs 16 and PCB 18. The cover 26 may include a ring portion 27 (e.g., a light tube) that is optically coupled to the LEDs 16 and is at least partially light transmissive to allow light emitted by the LEDs 16 to be transmitted therethrough and an opaque portion 28 located centrally on the cover 26. The cover 26 may be secured to the PCB 18 and/or wall 20 of the base section 10 using any means known in the art such as adhesives, mechanical fasteners, and the like. Alternatively, as exemplarily shown in FIG. 4, a dial 30 may be arranged over the LEDs 16 and PCB 18. The dial 30 is configured to be rotatable to allow a user to select between a variety of blender settings such as a low blender setting and a high blender setting for example. The dial 30 may also be configured to enable a user to select between various timed blender settings. In the presently illustrated embodiment, the dial 30 includes a ring portion 32 that is optically coupled to the LEDs 16 and is at least partially light transmissive to enable light emitted from the LEDs 16 to be transmitted therethrough.

In operation, when an activity is being performed by the blender, the control circuit 22 may selectively control an operational state of each of the LEDs 16 to visually indicate the progress of the activity. In controlling the LEDs, the control circuit 22 may receive input from a controller of the blender indicating that an activity has been initiated and the amount of time that is needed to complete the activity. In response, the control circuit 22 is programmed to control the operational state of the LEDs 16 accordingly to provide accurate progress information to a user. As described herein, the LEDs 16 may be selectively activated (turned ON), deactivated (turned OFF), dimmed, brightened, or a combination thereof.

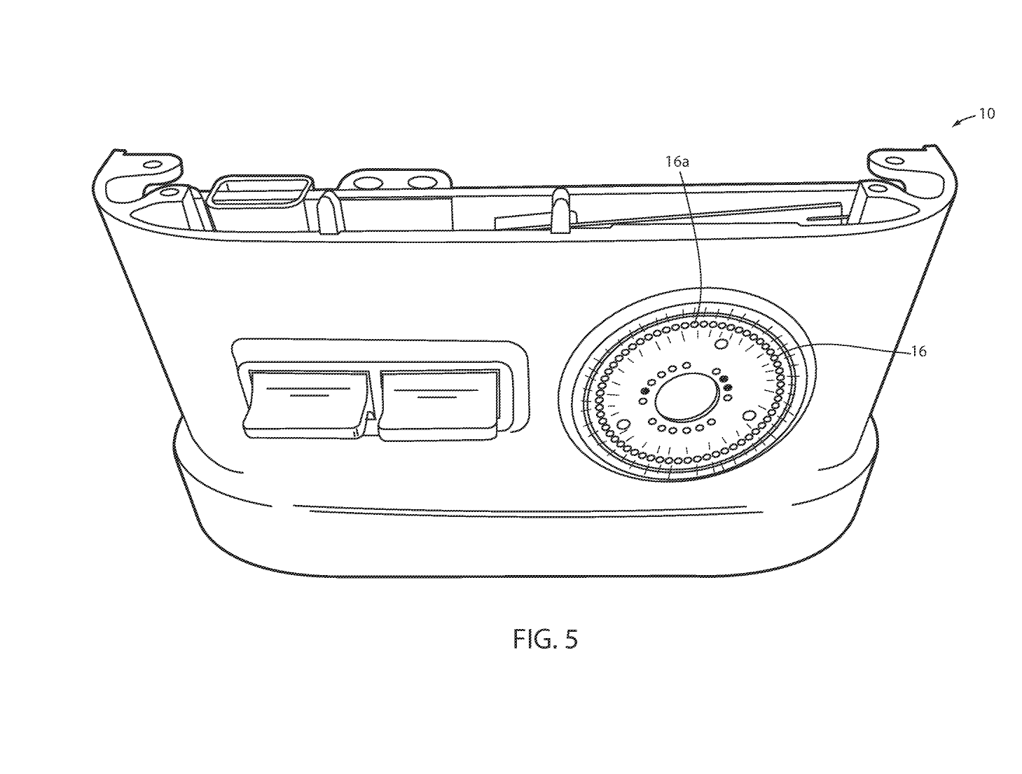

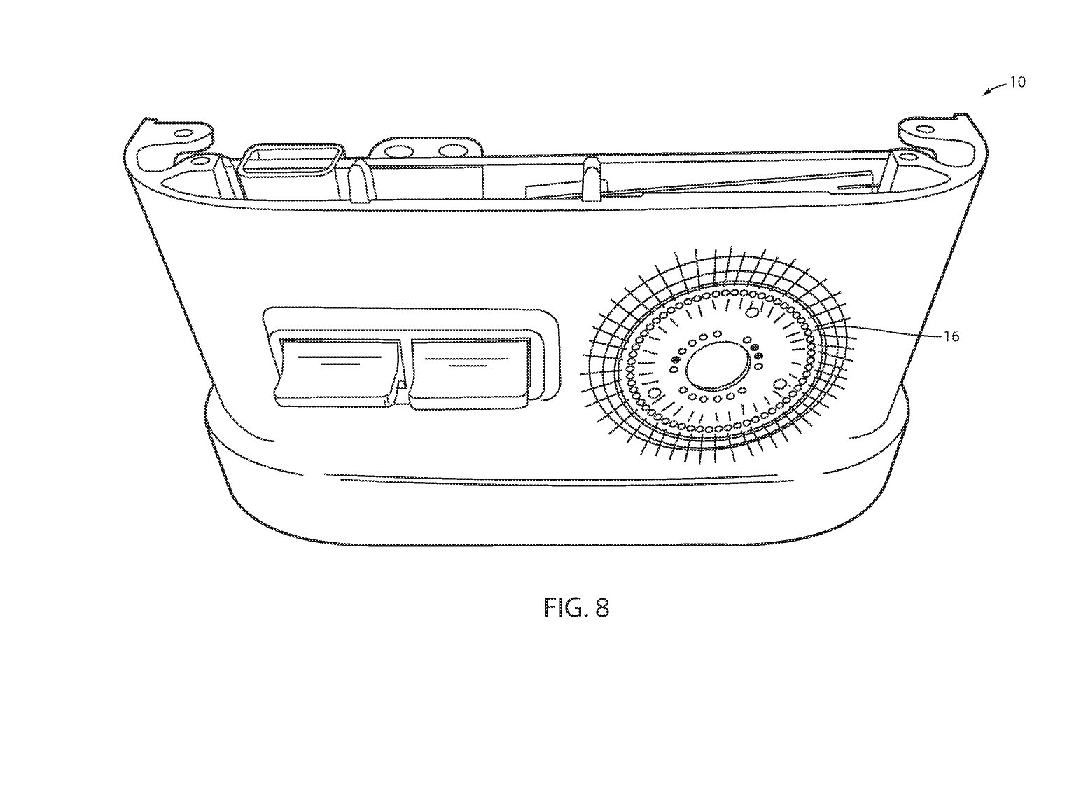

Referring to FIGS. 5-12, various embodiments of the progress tracking mechanism 14 are shown to demonstrate manners in which the progress tracking mechanism 14 may operate to allow a user to track the progress of a selected activity. For purposes of illustration, the LEDs 16 and PCB 18 are shown uncovered but may otherwise be covered by a cover (e.g., cover 26), a dial (e.g., dial 30), or other component(s). In addition, the LEDs 16 are exemplarily shown totaling sixty and are arranged in a ring with similar spacing between each LED 16. For purposes of illustration, undarkened LEDs 16 should be seen to correspond to an activated state whereas darkened LEDs 16 should be seen to correspond to a deactivated state. Additionally, with respect to the exemplary embodiments shown in FIGS. 8-11, the length of the light rays stemming from the LEDs 16 serve to demonstrate a relative brightness of the LEDs 16. Also, for purposes of understanding, the embodiments of the progress tracking mechanism 14 shown in FIGS. 5-7 will be described in relation to an activity having a one minute duration.

As shown in FIG. 5, each of the LEDs 16 may be turned ON prior to or at the onset of an activity. Once the activity begins, the LEDs 16 may be sequentially deactivated to enable a user to track the progress of the activity. In this instance, since there are sixty LEDs 16, the control circuit 22 may deactivate one LED 16 every second in either a clockwise or counterclockwise direction. Prior to the start of the activity, the progress tracking mechanism 14 may run an initiation sequence to cue the user that it is ready and/or to create an attractive visual effect. For example, it is contemplated that the initiation sequence includes sequentially activating the LEDs 16 in a counterclockwise direction (e.g., starting with LED 16a), followed by sequentially deactivating the LEDs 16 in a clockwise direction, and followed by sequentially activating the LEDs 16 in a counterclockwise direction and leaving them in an activated state to signal to the user to start the activity. It should be appreciated that the speed at which the LEDs 16 are activated/deactivated during the initiation sequence may be varied.

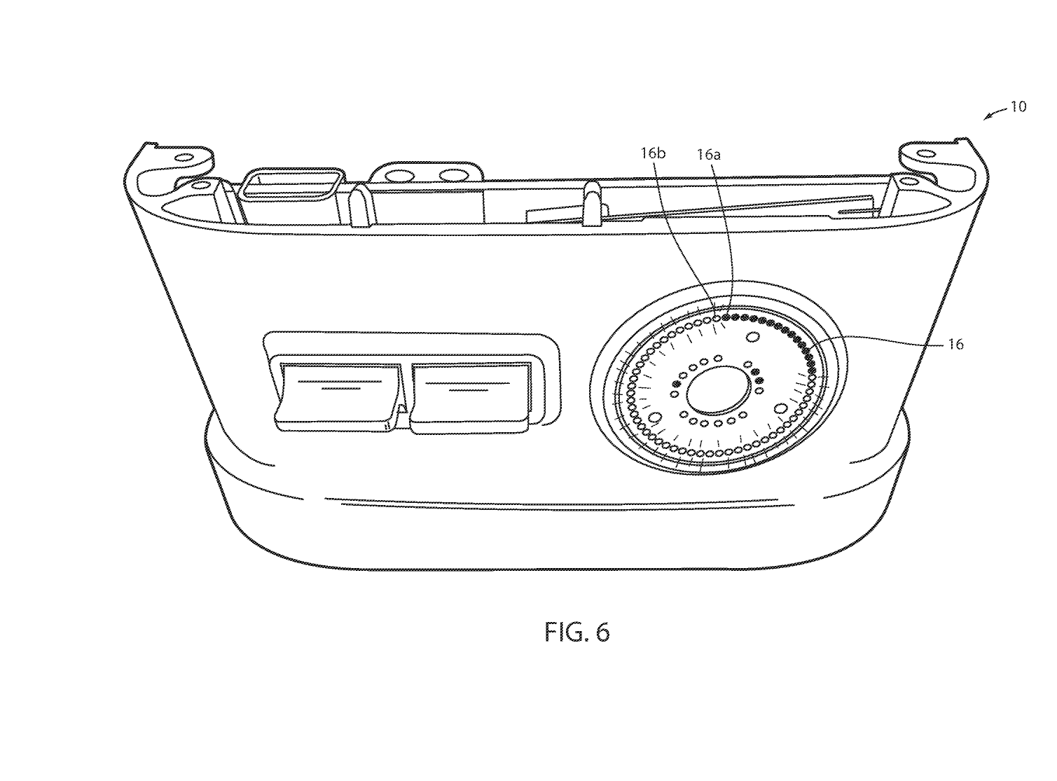

According to one embodiment, at the onset of an activity, the LEDs 16 are initially turned ON and sequentially deactivated in a clockwise manner beginning with the LED 16a located at the twelve o'clock position. As shown in FIG. 6, approximately one quarter of the LEDs 16 have been deactivated to indicate to a user that approximately 15 seconds have elapsed or approximately 45 seconds remain in the selected activity. Alternatively, if the user is unaware of how much time is assigned to the activity, the user may still track its progress based on the number of deactivated/activated LEDs 16. In regards to the example shown in FIG. 5, the user may ascertain that the activity is approximately one quarter way through or three quarter way remaining. As the activity progresses, a complimentary number of LEDs 16 will be sequentially deactivated in a clockwise direction. Upon the expiration of the activity, the last LED 16b will be deactivated, thereby informing the user that the activity has been completed. It is contemplated that in conjunction with sequentially deactivating the LEDs 16 as time elapses, those LEDs that are in an activated state may also be progressively brightened or dimmed to create an additional visual effect. With respect to each example provided herein, it is contemplated that a buzzer or other auditory alert may be sounded to further alert the user that the activity has finished.

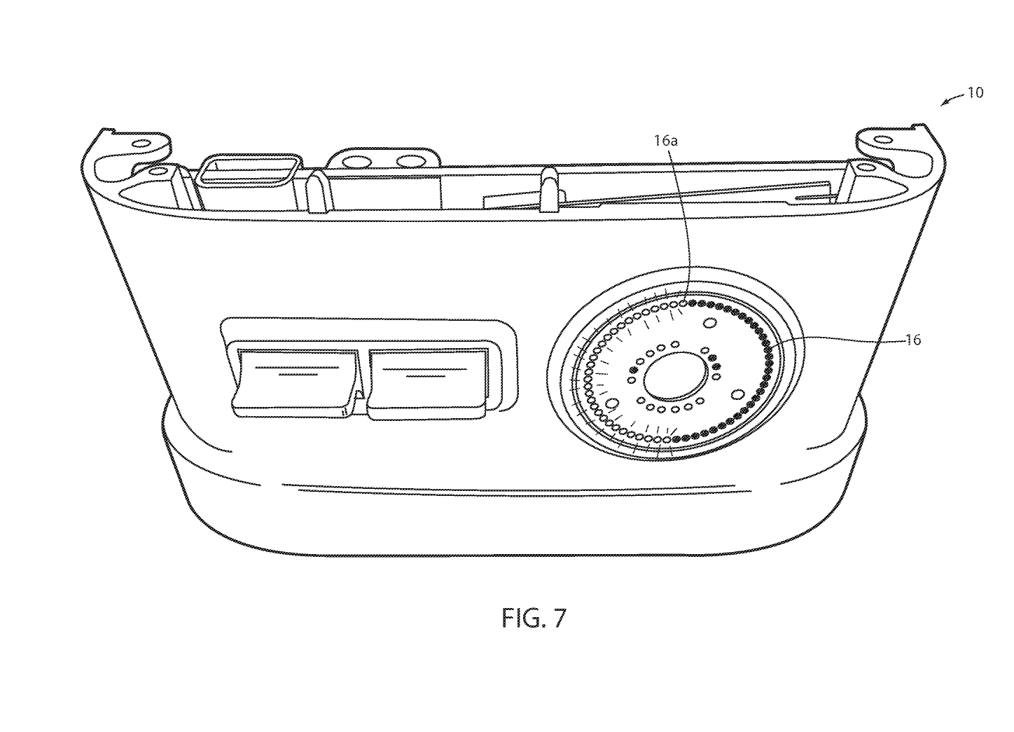

In an alternative embodiment, as shown in FIG. 7, the LEDs 16 may be initially turned OFF and sequentially activated when the activity is underway. The LEDs 16 may be sequentially activated (e.g., one LED 16 per second) in a counterclockwise direction beginning again with the LED 16a located at the twelve o'clock position. In the illustrated embodiment, approximately half of the LEDs 16 have been activated to indicate that approximately 30 seconds remains in the activity or otherwise indicate that the activity is halfway through. As time elapses, the remaining LEDs 16 will be activated in turn. By the time the activity has finished, all of the LEDs 16 will have become activated to indicate the completion of the activity. In one embodiment, the last LED 16 to become activated may have different light output characteristics than the remaining LEDs 16. For example, the last LED 16 to become activated may output light at a different color and/or intensity for added visual effect. Like the example provided in FIGS. 5 and 6, LEDs 16 that become activated may also be progressively brightened or dimmed to create an additional visual effect if desired. Furthermore, with respect to any of the embodiments described herein, the LEDs 16 may be operated in a blinking pattern once the activity has finished.

While the embodiments in FIGS. 5-7 have been described in reference to an activity having a one minute duration, it should be understood that activities having other durations may be similarly tracked by adjusting the amount of time before either activating or deactivating a subsequent LED 16. For an activity having a two minute duration, for example, the control circuit 22 may activate or deactivate an LED 16 every two seconds to ensure accurate progress tracking such that the last LED 16 becomes activated or deactivated by the time the activity expires.

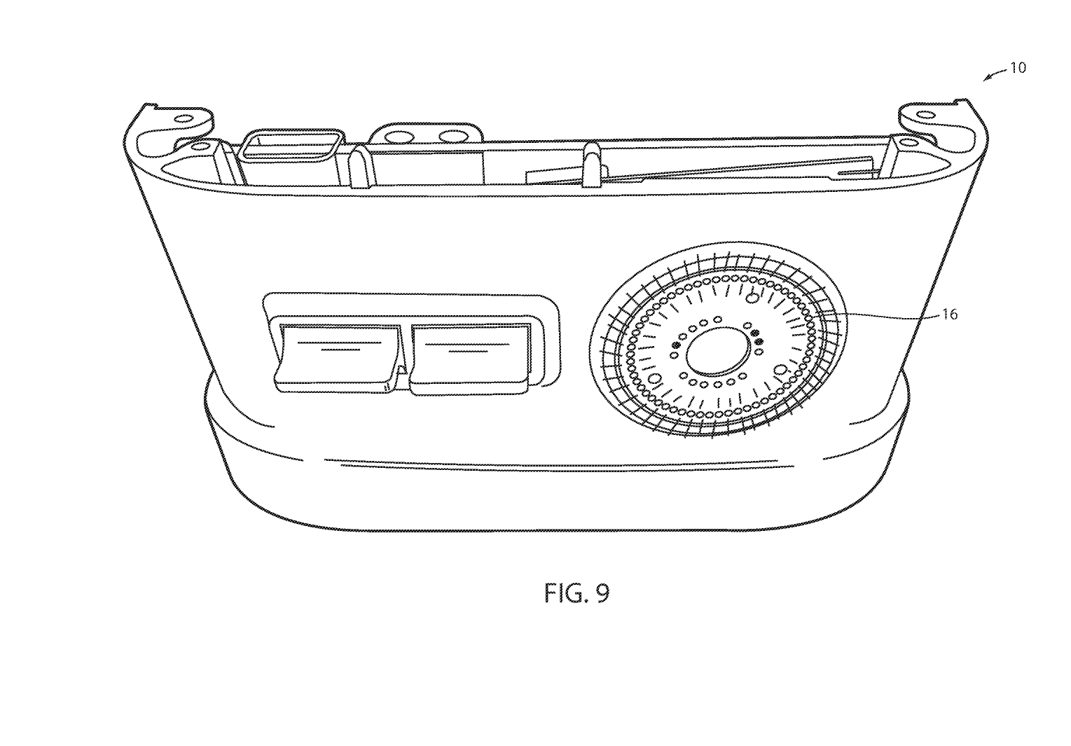

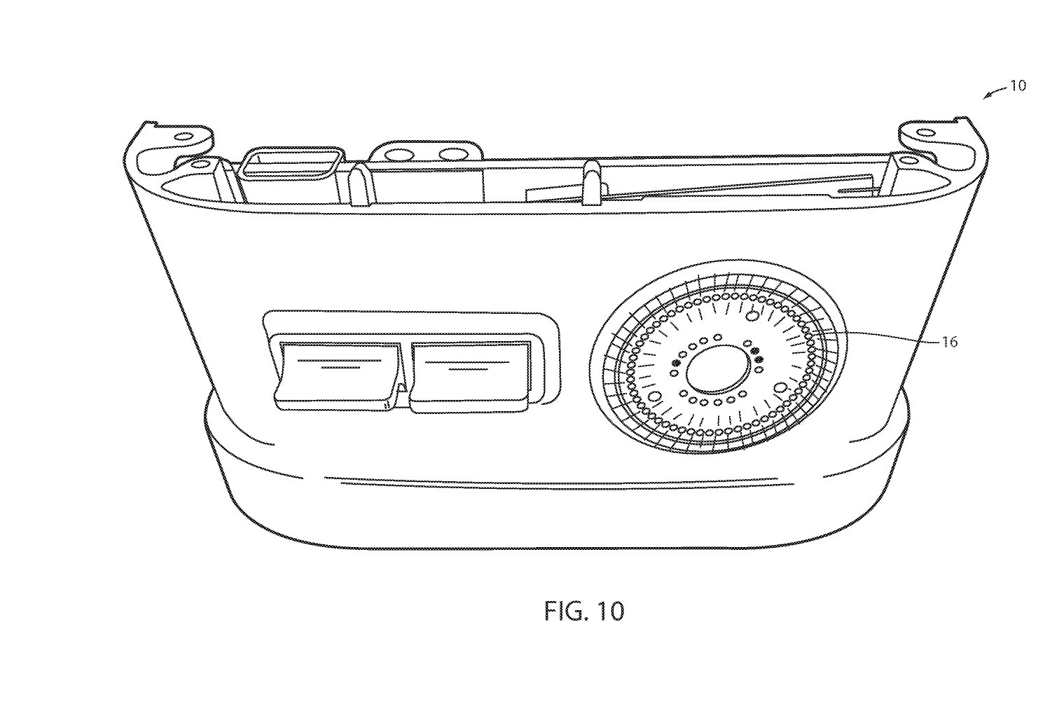

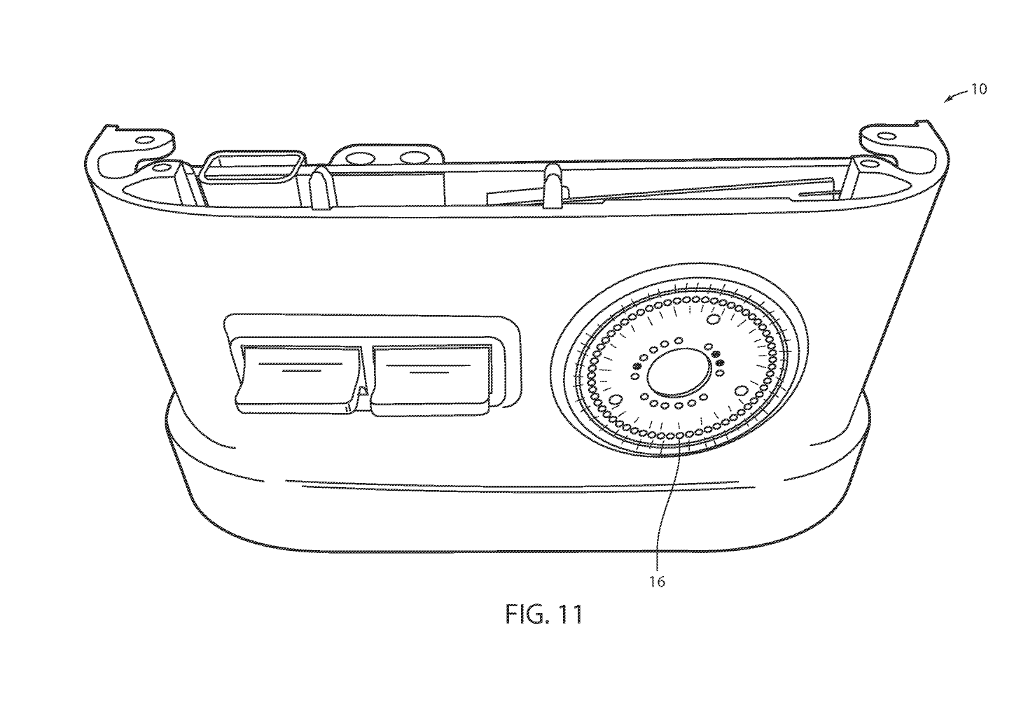

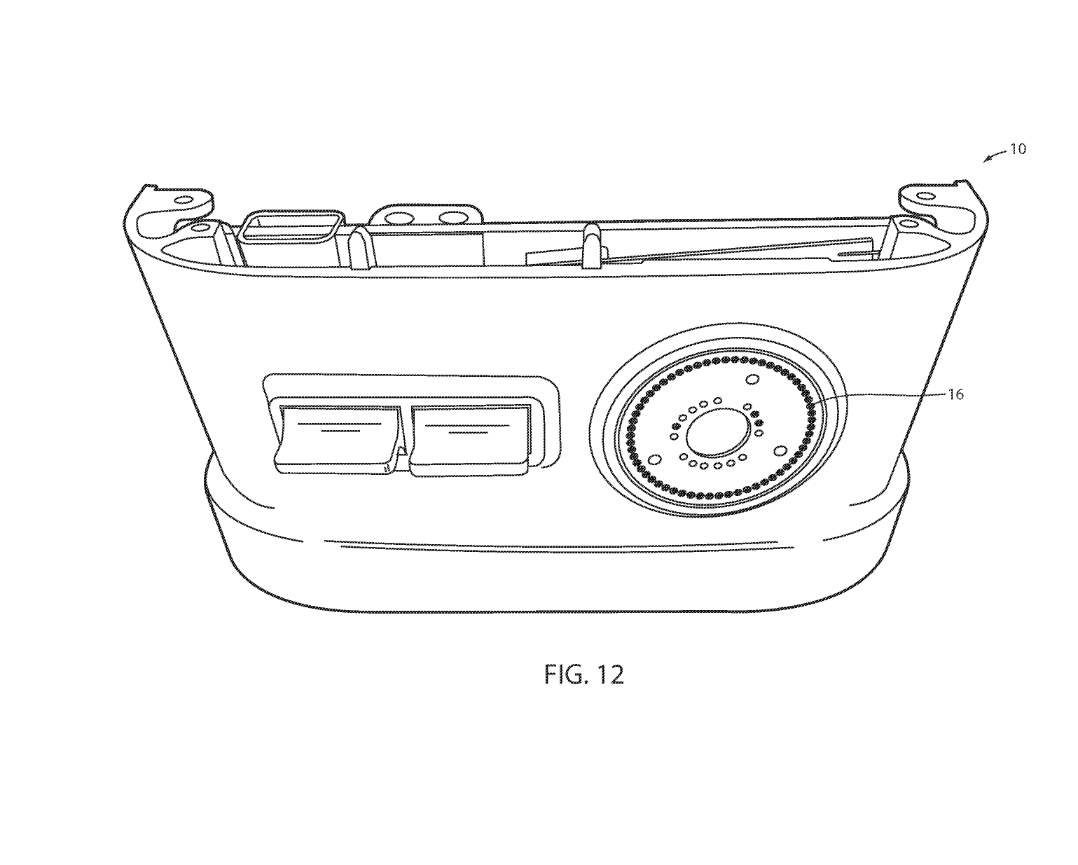

In yet another alternative embodiment, as shown in FIGS. 8-12, the brightness levels of the LEDs 16 may be progressively brightened or dimmed to enable the user to track the progress of the activity. For example, the brightness levels of the LEDs 16 may be decreased as time elapses. According to one embodiment, the control circuit 22 may operate the LEDs 16 at five brightness settings such as a high brightness setting, a medium-high brightness setting, a medium brightness setting, a low brightness setting, and a zero brightness setting (i.e., the LEDs 16 are deactivated). For example, the LEDs 16 may be operated at the high brightness setting (FIG. 8) prior to or at the onset of the activity. When the activity is a quarter way through, the LEDs 16 may be dimmed to the medium-high brightness setting (FIG. 9). When the activity is halfway through, the LEDs 16 may be dimmed to the medium brightness setting (FIG. 10). When the activity is three quarter way through, the LEDs 16 may be dimmed to the low brightness setting (FIG. 11). Finally, when the activity is finished, the LEDs 16 may be deactivated (FIG. 12). In alternative embodiments, the brightness level of the LEDs 16 may instead be increased as the activity progresses. For example, the LEDs 16 may initially be deactivated at the onset of the activity, followed in turn by the low, medium, medium-high, and high brightness setting at the appropriate time intervals such as those outlined above. In controlling the brightness levels of the LEDs 16, the control circuit 22 may use pulse width modulation or other conventional methods.

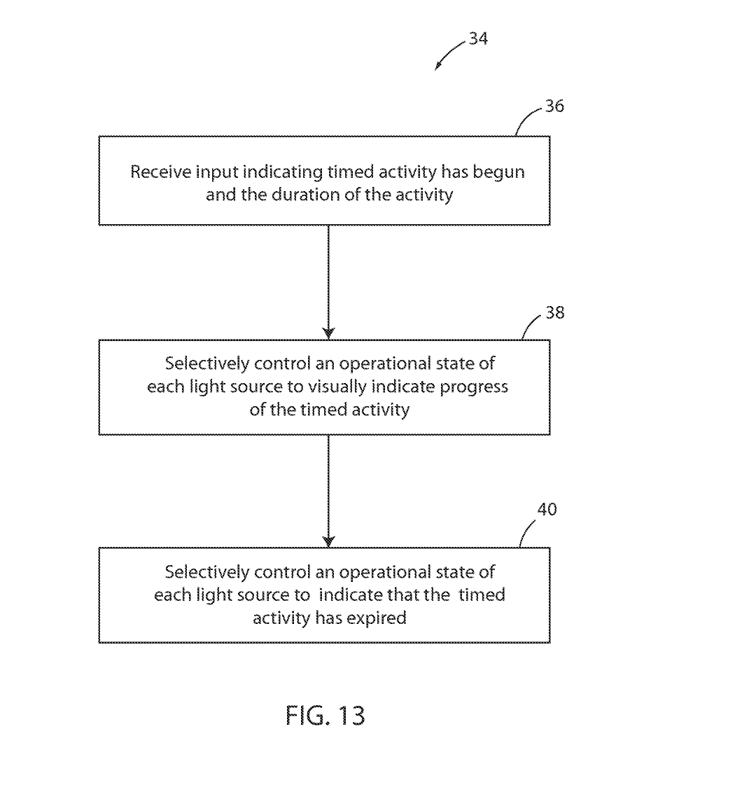

Referring to FIG. 13, is flow chart is shown of a method 34 for tracking the progress of a timed activity performed by a home appliance and will be described herein with further reference to the progress tracking mechanism 14 described herein. At step 36, the control circuit 22 receives input indicating that the timed activity has begun along with the duration of the activity. At step 38, the control circuit 22 selectively controls an operational state of each of the light sources (e.g., LEDs 16) to visually indicate the progress of the timed activity. As described herein, the LEDs 16 may be activated, deactivated, brightened, dimmed, or a combination thereof to enable a user to assess the progress of the timed activity. At step 40, the control circuit 22 again controls the operational state of each of the LEDs 16 to indicate that the timed activity has expired. This can be done by controlling an activated/deactivated state and/or a brightness level of the LEDs 16. In some embodiments, the expiration of a timed activity may be indicated by blinking the LEDs 16 and/or an auditory alert.

Accordingly, a progress tracking mechanism 14 has been advantageously provided herein to allow a user to track the progress of a selected activity based on an operational state of a plurality of LEDs 16. While the progress tracking mechanism 14 is described herein as part of a blender, it is contemplated that the progress tracking mechanism 14 may be similarly adapted to other home appliances such as washing machines, mixers, coffee makers, to name a few. It is also contemplated that more than one progress tracking mechanism 14 may be provided on a given home appliance if more than one function is to be tracked by the user. Each progress tracking mechanism 14 may be operated using a common controller, such as control circuit 22, or separate control circuits if desired.

It is important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the essence of the present disclosure, and further it is to be understood that the concepts set forth in this disclosure are intended to be covered by the following claims unless these claims by their language expressly state otherwise.

What is claimed is:

1. A progress tracking mechanism provided on a home appliance, comprising:
a plurality of light sources; and
a controller electrically coupled to the light sources, wherein when a timed activity is being performed by the home appliance, the controller selectively controls an operational state of each of the light sources to visually indicate the progress of the timed activity.

2. The progress tracking mechanism of claim 1, wherein the plurality of light sources are arranged in an ordered sequence.

3. The progress tracking mechanism of claim 2, wherein the controller activates each of the light sources prior to or at the onset of the timed activity, and wherein the controller sequentially deactivates the light sources based on an amount of time remaining in the timed activity such that all of the light sources become deactivated once the timed activity is completed.

4. The progress tracking mechanism of claim 2, wherein at the onset of the timed activity, the controller sequentially activates the light sources based on an amount of time remaining in the timed activity such that all of the light sources become activated once the timed activity is completed.

5. The progress tracking mechanism of claim 2, wherein the controller activates each of the light sources prior to or at the onset of the timed activity and progressively decreases a brightness level of each of the light sources based on an amount of time remaining in the timed activity.

6. The progress tracking mechanism of claim 2, wherein at the onset of the timed activity, the controller progressively increases a brightness level of each of the light sources based on an amount of time remaining in the timed activity.

7. The progress tracking mechanism of claim 1, wherein the operational state comprises an activated state, a deactivated state, a brightness level, or combination thereof.

8. A progress tracking mechanism provided on a home appliance, comprising:
a plurality of light sources arranged in a ring pattern; and
a controller electrically coupled to the light sources, wherein when a timed activity is being performed by the home appliance, the controller selectively controls an ON/OFF state and a variable brightness level of each of the light sources to visually indicate the progress of the timed activity.

9. The progress tracking mechanism of claim 8, wherein the controller activates each of the light sources prior to or at the onset of the timed activity, and wherein the controller sequentially deactivates the light sources in either a clockwise or counterclockwise direction, wherein the deactivation of the light sources occurs progressively based on an amount of time remaining in the timed activity such that all of the light sources become deactivated once the timed activity is completed.

10. The progress tracking mechanism of claim 8, wherein at the onset of the timed activity, the controller sequentially activates the light sources in either clockwise or a counterclockwise direction, wherein the activation of the light sources occurs progressively based on an amount of time remaining in the timed activity such that all of the light sources become activated once the timed activity is completed.

11. The progress tracking mechanism of claim 8, wherein the controller activates each of the light sources prior to or at the onset of the timed activity and progressively decreases a brightness level of each of the light sources based on an amount of time remaining in the timed activity.

12. The progress tracking mechanism of claim 8, wherein at the onset of the timed activity, the controller progressively increases a brightness level of each of the light sources based on an amount of time remaining in the timed activity.

13. The progress tracking mechanism of claim 8, wherein the operational state comprises an activated state, a deactivated state, a brightness level, or combination thereof.

14. A method for tracking the progress of a timed activity performed by a home appliance, comprising the steps of:
arranging a plurality of light sources in a ring pattern;
initiating a timed activity to be performed by the home appliance; and
selectively controlling an operational state of each of the light sources to visually indicate the progress of the timed activity.

15. The method of claim 14, wherein step of selectively controlling comprises sequentially deactivating the light sources in either a clockwise or counterclockwise direction, wherein the deactivation of the light sources occurs progressively based on an amount of time remaining in the timed activity such that all of the light sources become deactivated once the timed activity is completed.

16. The method of claim 14, wherein the step of selectively controlling comprises sequentially activating the light sources in either clockwise or a counterclockwise direction, wherein the activation of the light sources occurs progressively based on an amount of time remaining in the timed activity such that all of the light sources become activated once the timed activity is completed.

17. The method of claim 14, wherein the step of selectively controlling comprises activating each of the light sources prior to or at the onset of the timed activity and progressively decreasing a brightness level based on an amount of time remaining in the timed activity.

18. The method of claim 8, wherein the step of selectively controlling comprises progressively increasing a brightness level of each of the light sources based on to an amount of time remaining in the timed activity.

19. The method of claim 8, wherein the operational state comprises an activated state, a deactivated state, a brightness level, or combination thereof.

20. The method of claim 8, wherein the step of selectively controlling comprises blinking the light sources when the timed activity is completed.
